(19) United States
(12) Patent Application Publication
(10) Pub. No.: US 2012/0013101 A1
(43) Pub. Date: Jan. 19, 2012

(54) Modulized bicycle frame

(75) Inventors: Wei-Jean Huang, Taichung City (TW); Hui-Ling Chao, Taichung City (TW); Kun-Lung Tsai, Taichung City (TW); Yu-Che Huang, Taichung City (TW)

(73) Assignee: Cycling & Health Tech Industry R & D Center

(21) Appl. No.: 12/804,197

(22) Filed: Jul. 16, 2010

(51) Int. Cl. B62K 19/00

(52) U.S. Cl. 280/287

(57) ABSTRACT

A modulized bicycle frame includes at least two frame body members each sidelong symmetric to each other and having a head connecting portion, a seat connecting portion and a bottom-bracket connecting portion, and a plurality of fastening members for combining the frame body members to form the bicycle frame. The frame body members are easy to assemble and disassemble so as to facilitate replacement and modification of the modulized bicycle frame. Besides, the frame body members are suitable for mass manufacture, thereby saving manufacturing costs.

### BACKGROUND OF THE INVENTION

1. Technical Field

The present invention relates to bicycles, and more particularly, to a modulized bicycle frame, which is constituted from modulized frame body members, wherein the modulized frame body members can be easily assembled and replaced so that a user is allowed to design and realize his/her personalized bicycle frame.

2. Description of Related Art

With the progress of life quality, leisure activities and exercises have formed an important part of our daily life. Among others, bicycle riding is a popular exercise suitable for people of all ages. For safe and pleasing riding, it could not be more necessary to have a quality and reliable bicycle.

Conventionally, a bicycle frame is composed of a plurality of tubes and fittings, typically including a front frame formed by a head tube, a top tube, a down tube, a seat tube and a bottom bracket, and a rear frame formed by a seat stay and a chain stay that are extended from the seat tube and a bottom bracket, respectively. Such a bicycle frame traditionally has the front frame, the rear frame and the bottom bracket welded in to an integral frame body. While the traditional bicycle frame provides excellent structural stability, its appearance and size have been unchangeably determined at the time the parts are welded together.

However, consumers' appetite for styles and designs of bicycles is always changing with the fashion trends, and is often dampened by the immutability of the traditional bicycle frames. While buying a new frame is an alternative, whether the new frame accommodates the existing parts is another issue to be considered.

Since the immutability of the traditional bicycle frames substantially prohibits the multiplex combination and replacement of the tubes, it would be desired to have a modulized bicycle frame that allows a user to personalize the combination and helps manufacturers to save manufacturing costs.

### SUMMARY OF THE INVENTION

In view of the shortcomings of the existing devices, the present invention provides a modulized bicycle frame that is easy to assemble and disassemble.

The frame assembly has at least two frame body members that are sidelong symmetric to each other. Each of the frame body members may be made of a metal material or a plastic material. Between the frame body members, there are a head connecting portion, a seat connecting portion and a bottom-bracket connecting portion. The frame body members are combined by plural fastening members. One top tube portion is formed by the frame body members between the head connecting portion and the seat connecting portion. One down tube portion is formed by the frame body members between the head connecting portion and the bottom-bracket connecting portion. One seat tube portion is formed by the frame body members between the seat connecting portion and the bottom-bracket connecting portion. In addition, on the frame body members, a seat stay portion is extended from the seat connecting portion and running counter to the top tube portion while a chain stay portion is extended from the bottom-bracket connecting portion and running counter to the down tube portion. The chain stay portion is formed with a retaining notch for receiving an axle of a rear wheel.

Each of the frame body members of the frame assembly may be composed of a front piece and a rear piece. The front piece includes the top tube portion, the down tube portion and the seat tube portion, while the rear piece includes the seat stay portion, the chain stay portion and another seat tube portion.

By connecting the head connecting portion, the seat connecting portion and the bottom-bracket connecting portion to the frame body members, the modulized bicycle frame is assembled.

One objective of the present invention is to provide the above-disclosed modulized bicycle frame, wherein a user is allowed to assemble the modulized bicycle frame at his/her will by connecting the frame body members, the head connecting portion, the seat connecting portion and the bottom-bracket connecting portion, so as to endow the modulized bicycle frame with the possibility of modification and wherein the modulized components are suitable for mass manufacture and thereby save manufacturing costs.

Another objective of the present invention is to provide the above-disclosed modulized bicycle frame, wherein the top tube portions, the down tube portions, the seat tube portions, the seat stay portion and the chain stay portions are also configured to cover a bicycle frame of a traditional bicycle, so as to meet decorative needs and reinforce the structural stability of the frame of the traditional bicycle.

Another objective of the present invention is to provide the above-disclosed modulized bicycle frame, wherein the frame assembly may be made of metal or plastic so as to have a structural strength sufficient for the frame assembly to replace a bicycle frame of a traditional bicycle, so the present invention can be implemented with or without a traditional bicycle for improved versatility.

Another objective of the present invention is to provide the above-disclosed modulized bicycle frame, wherein the frame assembly may be made through pressing when made of metal or alloy, or may be made through injection molding when made of plastic, both being suitable for mass manufacture that saves manufacturing costs and reducing the number of separate parts. Thereby, it is convenient for a user to assemble and carry.

### BRIEF DESCRIPTION OF THE DRAWINGS

The invention as well as a preferred mode of use, further objectives and advantages thereof will be best understood by reference to the following detailed description of illustrative embodiments when read in conjunction with the accompanying drawings, wherein:

FIG. 1 is an exploded view of a modulized bicycle frame according to a first embodiment of the present invention;

FIG. 2 is a perspective of the modulized bicycle frame according to the first embodiment of the present invention;

FIG. 3 is an exploded view of a modulized bicycle frame according to a second embodiment of the present invention

FIG. 4 is a perspective of the modulized bicycle frame according to the second embodiment of the present invention;

FIG. 5 is a cross-sectional view of the modulized bicycle frame according to the second embodiment of the present invention; and

FIG. 6 is a perspective of a modulized bicycle frame according to a third embodiment of the present invention.

### DETAILED DESCRIPTION OF THE INVENTION

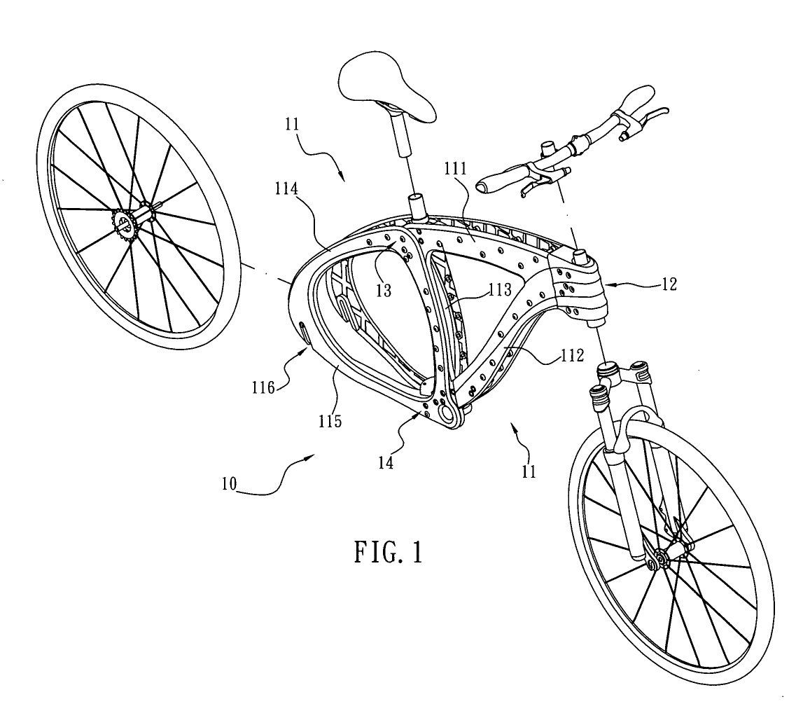

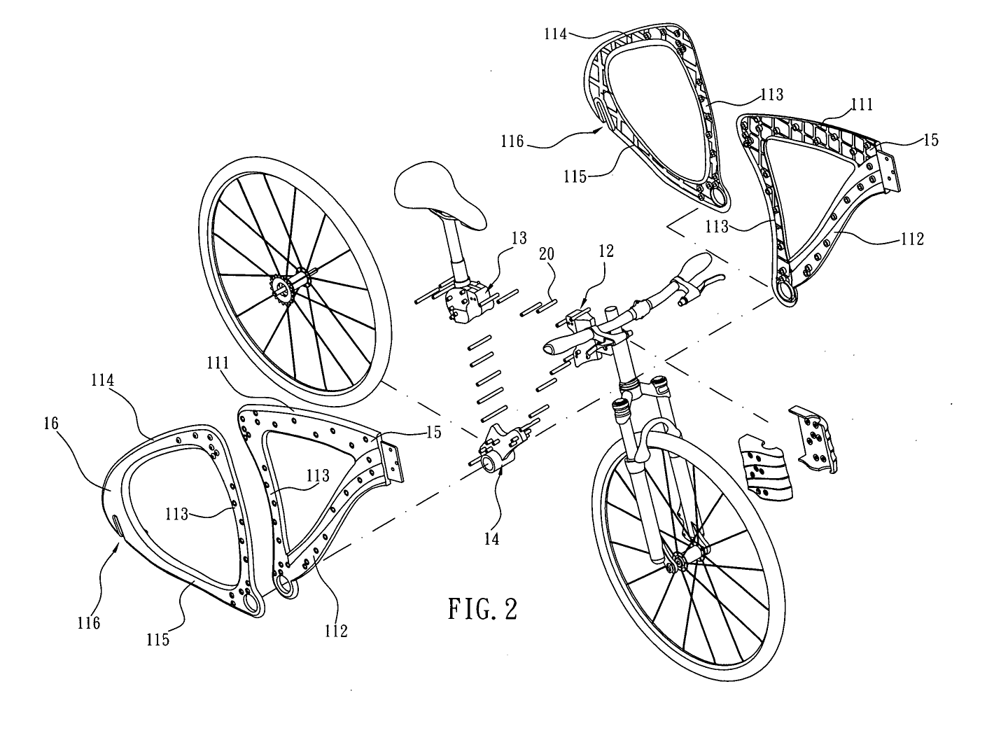

Referring to FIG. 1 and FIG. 2, a modulized bicycle frame of the present invention is primarily composed of at least one frame assembly 10 and a plurality of fastening member 20, which will be illustrated in detail below.

The frame assembly 10 has at least two frame body members 11 that are sidelong symmetric to each other. Each of the frame body members 11 may be made of a metal material or a plastic material. Between the frame body members 11, there are a head connecting portion 12, a seat connecting portion 13 and a bottom-bracket connecting portion 14. The head connecting portion 12 is configured to receive a handle, a front fork and a front wheel. The seat connecting portion 13 is configured to receive a seat. The bottom-bracket connecting portion 14 is configured to receive a mechanism driving a bicycle, such as crank, a chainwheel, pedals and other necessary parts.

At least one top tube portion 111 is formed by the frame body members 11 between the head connecting portion 12 and the seat connecting portion 13. At least one down tube portion 112 is formed by the frame body members 11 between the head connecting portion 12 and the bottom-bracket connecting portion 14. Furthermore, at least one seat tube portion 113 is formed by the frame body members 11 between the seat connecting portion 13 and the bottom-bracket connecting portion 14. In addition, on the frame body members 11, a seat stay portion 114 is extended from the seat connecting portion 13 and running counter to the top tube portion 111 while a chain stay portion 115 is extended from the bottom-bracket connecting portion 14 and running counter to the down tube portion 112. The chain stay portion 115 is formed with a retaining notch 116 for receiving an axle of a rear wheel.

The plural fastening members 20 serve to provide combination between the frame body member 11 and the head connecting portion 12 and between the seat connecting portion 13 and the bottom-bracket connecting portion 14 so as to make the frame body members 11 assembled to each other. The fastening member 20 may be bolts, rivets, blind rivets or tenon-mortise structures.

FIG. 1 and FIG. 2 illustrate the first embodiment of the present invention. Therein, for the sake of mass manufacture, each of the frame body members 11 of the frame assembly 10 may be composed of a front piece 15 and a rear piece 16. The front piece 15 includes the top tube portion 111, the down tube portion 112 and the seat tube portion 113, while the rear piece 16 includes the seat stay portion 114, the chain stay portion 115 and another seat tube portion 113. The front piece 15 and the rear piece 16 are such assembled that the seat tube portions 113 thereof are overlapped, and the fastening members 20 make the head connecting portion 12, the seat connecting portion 13 and the bottom-bracket connecting portion 14 correspondingly assembled.

Upon assembling the top tube portions 111, the down tube portions 112 and the seat tube portions 113 of the front pieces 15, a top tube, a down tube and a seat tube as those known in a traditional bicycle are formed. By assembling the seat stay portions 114 and the chain stay portions 115 of the rear pieces 16, a seat stay and a chain stay as those known in a traditional bicycle are formed. The fastening members 20 serve to not only fasten the frame body members 11, but also hold the head connecting portion 12, the seat connecting portion 13 and the bottom-bracket connecting portion 14 together, thereby ensuring the solidness and stability of the head tube, the seat tube and the bottom bracket such constructed. A user is thus allowed to choose any said frame assembly 10 of his/her favorite style to form his/her personalized bicycle frame. In addition, when a manufacturer produces the subject matter of the present invention, as long as the frame body members 11 are with the relative positions and distance between the head connecting portion 12, the seat connecting portion 13 and the bottom-bracket connecting portion 14 fixed, the frame body members 11 of different appearances can be assembled with existing parts without problem, so a user can replace the frame body members 11 easily as often as he/she wants.

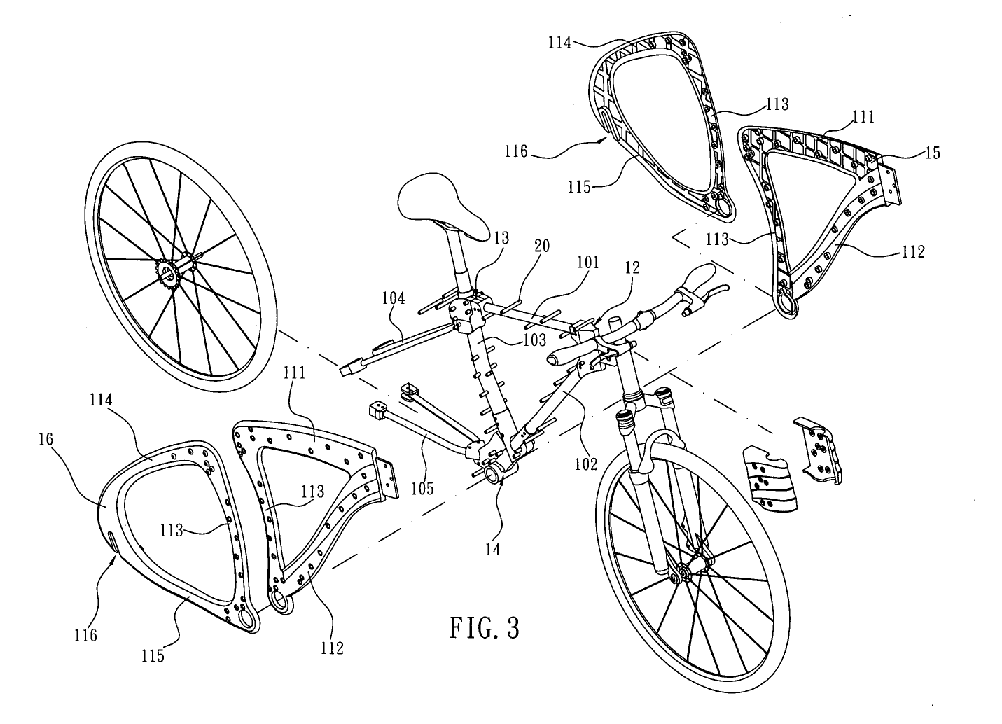

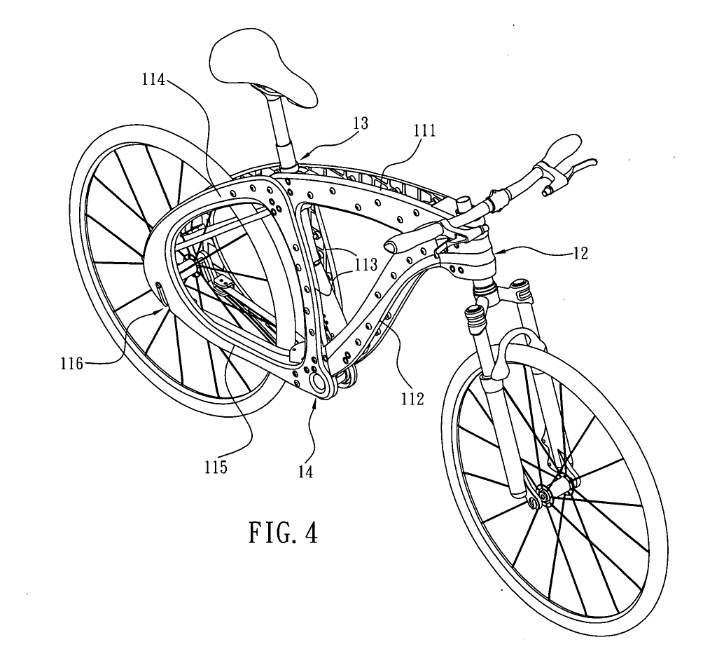

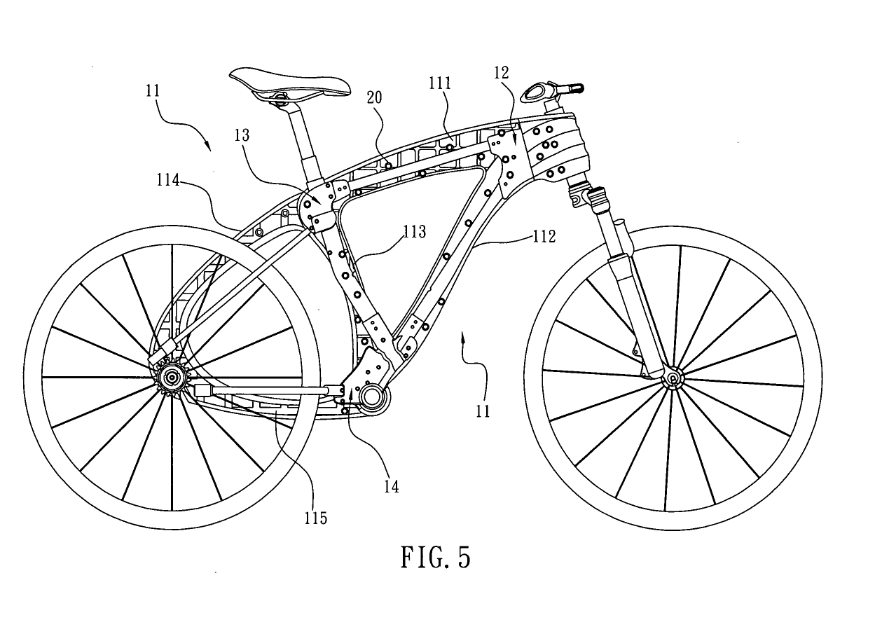

Referring to FIG. 3 through FIG. 5, in another embodiment of the present invention, all components of the previously discussed embodiment are incorporated. Furthermore, there is a top tube 101 provided between the head connecting portion 12 and the seat connecting portion 13, a down tube 102 provided between the head connecting portion 12 and the bottom-bracket connecting portion 14, and a seat tube 103 provided between the seat connecting portion 13 and the bottom-bracket connecting portion 14. The seat connecting portion 13 has two seat stay tubes 104 extended counter to the top tube 101 while the bottom-bracket connecting portion 14 has two chain stay tube 105 extended counter to the down tube 102. In assembly, the top tube 101 is sandwiched by the top tube portions 111, and the down tube 102 is sandwiched by the down tube portions 112, while the seat tube 103 is sandwiched by the seat tube portions 113. The seat stay portions 114 sandwich the seat stay tubes 104 and the chain stay portions 115 sandwich the chain stay tubes 105.

Alternatively, the present invention may be applied to a traditional bicycle so as to add the head connecting portion 12, the seat connecting portion 13 and the bottom-bracket connecting portion 14 to the traditional bicycle. In such a case, the top tube portions 111, the down tube portions 112, and the seat tube portions 113 of the frame body members 11 are respectively aligned and combined so as to receive a top tube 101, a down tube 102 and a seat tube 103 of the traditional bicycle, respectively. Meantime, the seat stay portions 114 and the chain stay portions 115 cover a seat stay tube 104 and a chain stay tube 105 of the traditional bicycle from outside. Thereby, the top tube portions 111, the down tube portions 112, the seat tube portions 113, the seat stay portions 114 and the chain stay portion 115 can removably wrap the frame of the traditional bicycle for a decorative purpose while the frame body members jointly reinforce the structural stability of the frame of the traditional bicycle.

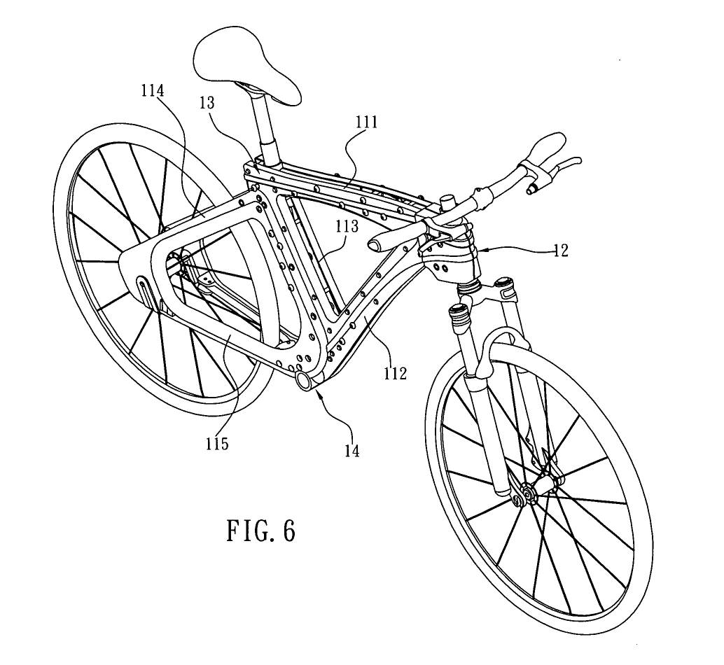

Referring to FIG. 6, in another embodiment of the present invention, all components of the previously discussed embodiment are incorporated. Furthermore, the frame body members 11 are each a one-piece structure with the front frame and the rear frame integrated, so as to further improve the integrity and stability of the assembled modulized bicycle frame.

The present invention has been described with reference to the preferred embodiments and it is understood that the embodiments are not intended to limit the scope of the present invention. Moreover, as the contents disclosed herein should be readily understood and can be implemented by a person skilled in the art, all equivalent changes or modifications which do not depart from the concept of the present invention should be encompassed by the appended claims.

What is claimed is:

1. A modulized bicycle frame, comprising:
at least two frame body members, a head connecting portion, a seat connecting portion and a bottom-bracket connecting portion, wherein the frame body members are configured to be combined mutually by a plurality of fastening members to hold the head connecting portion, the seat connecting portion and the bottom-bracket connecting portion in position.

2. The modulized bicycle frame of claim 1, wherein the fastening members are a plurality of bolts.

3. The modulized bicycle frame of claim 1, where each of the frame body members further comprises at least one top tube portion between the head connecting portion and the seat connecting portion, at least one down tube portion between the head connecting portion and the bottom-bracket connecting portion, and at least one seat tube portion between the seat connecting portion and the bottom-bracket connecting portion.

4. The modulized bicycle frame of claim 3, wherein each of the frame body members has a seat stay portion extended from the seat connecting portion and running counter to the top tube portion, and has a chain stay portion extended from the bottom-bracket connecting portion and running counter to the down tube portion.

5. The modulized bicycle frame of claim 4, wherein the chain stay portion is formed with a retaining notch for receiving an axle of a rear wheel.

6. The modulized bicycle frame of claim 4, wherein each of the frame body members is composed of a front piece and a rear piece, the front piece including the top tube portion, the down tube portion and the seat tube portion, the rear piece including the seat stay portion, the chain stay portion and another seat tube portion, so that when the frame body members are assembled, the seat tube portions of the front pieces and the rear pieces of the frame body members are overlapped and the fastening members fasten the head connecting portion, the seat connecting portion and the bottom-bracket connecting portion to the assembled frame body members.

7. The modulized bicycle frame of claim 4, further comprising a top tube between the head connecting portion and the seat connecting portion, a down tube between the head connecting portion and the bottom-bracket connecting portion, and a seat tube between the seat connecting portion and the bottom-bracket connecting portion.

8. The modulized bicycle frame of claim 7, wherein the seat connecting portion has two seat stay tubes extended counter to the top tube while the bottom-bracket connecting portion has two chain stay tubes extended counter to the down tube.

9. The modulized bicycle frame of claim 8, wherein when combined mutually, the frame body members hold the top tube between the top tube portions, the down tube between the down tube portions, the seat tube between the seat tube portions, the seat stay tubes between the seat stay portions, and the chain stay tubes between the chain stay portions.

10. The modulized bicycle frame of claim 1, wherein the frame body members are made of a metal material or a plastic material.
